(19) United States
(12) Patent Application Publication
(10) Pub. No.: US 2010/0121809 A1
(43) Pub. Date: May 13, 2010

(54) Method and system for predicting test time

(76) Inventors: Joachim Holz, Roth (DE); Axel Reitinger, Munich (DE)

Correspondence Address: HARNESS, DICKEY & PIERCE, P.L.C., P.O.BOX 8910, RESTON, VA, 20195, US

(21) Appl. No.: 12/461,991

(22) Filed: Aug. 31, 2009

Related U.S. Application Data
(60) Provisional application No. 61/114,105, filed on Nov. 13, 2008.

(51) Int. Cl. G06N 7/02

(52) U.S. Cl. 706/52

(57) ABSTRACT

A computer implemented method and a system are disclosed for predicting the remaining numbers of error or the remaining time to the end of test mainly applicable in software projects. In at least one embodiment, the prediction can be improved by using the test progress of the current project and the gradient derived from at least one former project having similar characteristics as the current project e.g. release developments for determining parameters for a reliability growth model. The method and the system can be implemented by adapted software and hardware commercially available off the shelf.

### CROSS REFERENCE TO RELATED APPLICATIONS AND PRIORITY STATEMENT

The present application hereby claims priority under 35 U.S.C. §119 (e) on U.S. Provisional Application No. 61/114,105 filed Nov. 13, 2008, the contents of which are hereby incorporated by reference herein in its entirety.

### FIELD

At least one embodiment of the invention generally relates to a method, a system and/or a computer readable medium for predicting the remaining test time or the remaining errors in software development projects. At least one embodiment of the invention is particularly applicable in the stage of system test.

### BACKGROUND

The main scope of System Test, in the software development process, is to prove that there is a minimum number of critical faults in the software. One of the challenges for Project Managers and System Test Managers is the prediction of the remaining necessary test time until the software can be considered as mature enough to end the test phase. There are in general at least two conditions, which have to be fulfilled:
all planned test cases have been successfully performed,
all critical errors which were found are solved.

Depending on the needs and available data, different prediction models can be used to estimate the remaining test time or number of faults until the test will be finished. In the software development process “software reliability growth models” are used to predict and assess a software product's reliability or to estimate the number of remaining latent defects.

The literature (see Stephan H. Kan, Metrics and Models in Software Quality Engineering Second Edition, Boston: Addison-Wesley, 2003) documents static and dynamic reliability growth models. Static models do not consider time. Dynamic software reliability growth models can be classified into two categories: those that model the entire development process and those that model the back-end testing phase. A common denominator of dynamic models is that they are expressed as a function of time in development. For instance common reliability growth models are:

1. Jelinski-Morana

2. Goel-Okumoto

3. Musa Okumoto (logarithmic Model)

4. Littlewood-Verrall.

It is common for the mentioned reliability growth models, that they rely either on fault detection rate per time unit (e.g. per week) or the duration between the occurrence of two faults or test progress. Another prerequisite for the usage of these models is a reasonable high number of data (e.g. faults detected) to make reliable prediction.

### SUMMARY

Although these reliability growth models enable to predict the necessary time to reach a requested maturity of the software in terms of remaining errors, these models do not allow to evaluate, if this prediction is in line with the test progress. The drawback of all reliability growth models is an uncertainty in terms of prediction accuracy. The major reason for this lies in the ignoring of data from historical (former) projects.

Predicting the remaining test time based on the test progress is a simple method. It is assumed that test progress per time unit is either equal or has an S-Curve characteristic. The test is finished, when 100% test progress is reached. Further on, all test cases, which have to be performed, are known and result in 100% test cases. The drawback of the test progress is similar to the drawback of the reliability growth models. When not taking historical data into consideration, the uncertainty in terms of prediction accuracy is increasing.

At least one embodiment of the present invention provides an approach to overcome these problems and drawbacks by using the test progress of the current project and by using data derived from at least one predecessor project as input for the estimation of the parameters of the reliability growth model. At least one embodiment of the invention may be implemented using hardware or software.

One aspect of at least one embodiment of the present invention is a computer implemented method for predicting residual test time of a current project, the method including an operation performed by a computer device, comprising:

providing fault detecting data from the current project; determining a test progress per time unit based on the fault detecting data of the current project;

determining an error finding rate per time unit based on the fault detecting data of the current project;

determining an error closing rate per time unit based on the fault detecting data of the current project;

projecting a residual time to finish the test of the current project by calculating a data point representing the end of the test;

providing fault detecting data from at least one historical project having similar characteristics as the current project;

determining the test progress per time unit of each respective historical project based on the respective fault detecting data;

determining the error finding rate per time unit of each respective historical project based on the fault detecting data;

determining the parameters of a reliability growth model of the historical projects based on the test progress, and the error finding rate of the respective historical projects;

deriving a gradient based on the reliability growth model of the historical projects;

calculating parameters of a reliability growth model of the current project, wherein the parameters are calculated by using data points derived from the current project, the test progress of the current project, the error finding rate of the current project, the error closing of the current project, and the gradient of the historical projects;

determining the residual test time of the current project based on a correlation between the gradient of the historical projects and the fault detecting data from the current project; and

displaying the residual test time on a monitor.

Another aspect of at least one embodiment of the invention is a system for predicting residual test time of a current project, the system comprising:

a computer executing an operation including:
providing fault detecting data from the current project;
determining a test progress, an error finding rate and an error closing rate per time unit by using the fault detecting data of the current project;
projecting a residual time to finish the test of the current project by calculating a data point representing the end of the test;
providing fault detecting data from at least one historical project having similar characteristics as the current project;
determining the test progress and the error finding rate per time unit of each respective historical project by using the respective fault detecting data;
determining the parameters of a reliability growth model of the historical projects by using the test progress and the error finding rate of the respective historical projects;
deriving a gradient by using the reliability growth model of the historical projects;
calculating parameters of a reliability growth model of the current project, wherein the parameters are calculated by using data points derived from the current project, the test progress of the current project, the error finding rate of the current project, the error closing of the current project, and the gradient of the historical projects; and
determining the residual test time of the current project by using a correlation between the gradient of the historical projects and the fault detecting from the current project; and

a displaying unit for displaying the residual test time.

A further aspect of at least one embodiment of the invention is a system for determining residual test time or residual errors of a current development project, the system comprising:

a first error detection unit for identifying errors in the current project;

a first determination unit for determining a test progress, an error finding rate and an error closing rate per time unit based on the identified errors of the current project, wherein a residual time to finish the test of the current project is determined by calculating a data point representing the end of the test;

a second error detection unit for identifying errors of at least one historical project having similar characteristics as the current project;

a second determination unit for
determining the test progress and the error finding rate per time unit of each respective historical project based on the respective errors; and
determining the parameters of a reliability growth model of the historical projects based on the test progress, and the error finding rate of the respective historical projects;

a calculating unit for
deriving a gradient based on the reliability growth model of the historical projects;
calculating parameters of a reliability growth model of the current project, wherein the parameters are calculated by using data points derived from the current project, the test progress of the current project, the error finding rate of the current project, the error closing of the current project, and the gradient of the historical projects; and
determining the residual test time or the residual errors of the current project based on a correlation between the gradient of the historical projects and the fault detecting data from the current project; and

a memory unit for storing the residual test time or the residual errors.

Furthermore at least one embodiment of the invention comprises a computer readable recording medium, having a program recorded thereon, wherein the program when executed is to make a computer execute a method comprising:

providing fault detecting data from the current project;

determining a test progress per time unit based on the fault detecting data of the current project;

determining an error finding rate per time unit based on the fault detecting data of the current project;

determining an error closing rate per time unit based on the fault detecting data of the current project;

projecting a residual time to finish the test of the current project by calculating a data point representing the end of the test;

providing fault detecting data from at least one historical project having similar characteristics as the current project;

determining the test progress per time unit of each respective historical project based on the respective fault detecting data;

determining the error finding rate per time unit of each respective historical project based on the fault detecting data;

determining the parameters of a reliability growth model of the historical projects based on the test progress, and the error finding rate of the respective historical projects;

deriving a gradient based on the reliability growth model of the historical projects;

calculating parameters of a reliability growth model of the current project, wherein the parameters are calculated by using data points derived from the current project, the test progress of the current project, the error finding rate of the current project, the error closing of the current project, and the gradient of the historical projects; and
determining the residual test time of the current project based on a correlation between the gradient of the historical projects and the fault detecting data from the current project.

### BRIEF DESCRIPTION OF THE DRAWINGS

The above-mentioned and other concepts of the present invention will now be addressed with reference to the drawings of the example embodiments of the present invention. The shown embodiments are intended to illustrate, but not to limit the invention. The drawings contain the following figures, in which like numbers refer to like parts throughout the description and drawings and wherein:

FIG. 1 shows an example schematic block diagram illustrating an approach to predict test end data without using data from historical projects,

FIG. 2 shows an example schematic block diagram illustrating an approach to predict test end data by using data from historical projects and from the current project,

FIG. 3 shows an example schematic overview flow diagram to calculate parameters of the reliability growth model by using the residual time to finish the test of the current project,

FIG. 4 shows an example schematic overview flow diagram to calculate parameters of the reliability growth model by using gradients derived from data of historical projects,

FIG. 5 shows an example schematic block diagram illustrating inputs and outputs of the processing unit to perform an embodiment of the present invention,

FIG. 6 shows a detailed flow diagram to calculate parameters of the reliability growth model by using the test progress of the current project,

FIG. 7 shows a detailed flow diagram to calculate parameters of the reliability growth model by using gradients derived from data of historical projects,

FIG. 8 shows two output diagrams, the upper diagram shows the results of calculating the fault detection rate with use of the test progress, the lower diagram shows the results of calculating the fault detection rate without using the test progress,

FIG. 9 shows an output diagram illustrating the calculated fault detection rate by using the gradient derived from at least one historical project, and

FIG. 10 shows an example image on a displaying unit illustrating output results of an embodiment of the present invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

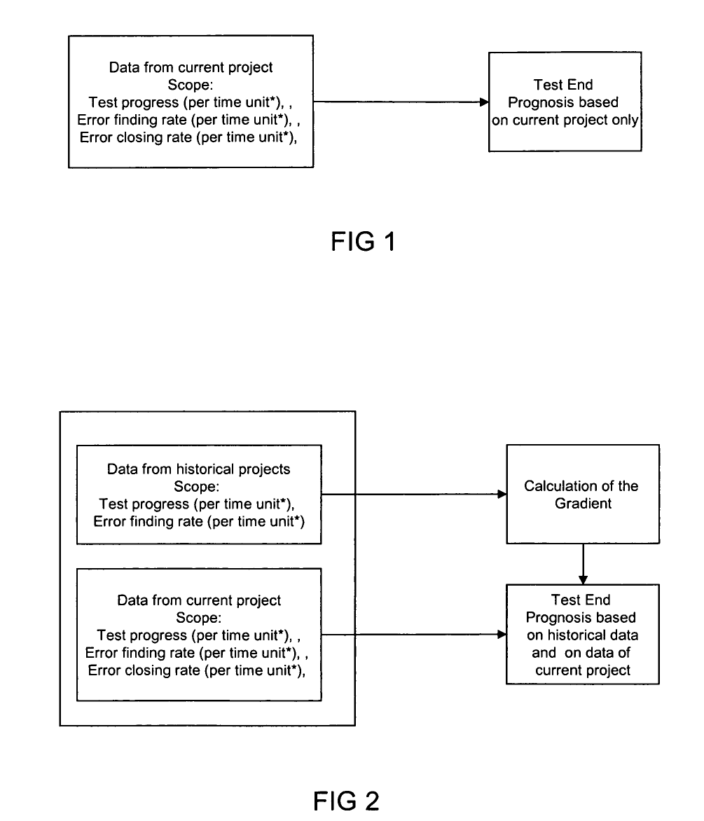

It will be readily understood that the components of the present invention, as generally described and illustrated in the Figures herein, may be arranged and designed in a wide variety of different configurations. Thus, the following more detailed description of the embodiments of the present invention, as represented in FIGS. 1 through 10, is not intended to limit the scope of the invention, as claimed, but is merely representative of selected embodiments of the invention.

FIG. 1 shows an example schematic block diagram illustrating an approach to predict test end data based on test data (e.g. test progress per time unit, error finding rate per time unit, error closing rate per time unit) derived from the current project, advantageously a software development project. Predicting the remaining or residual test time based on the test progress is a simple method. It is assumed that test progress per time unit is either equal or has an S-Curve characteristic. The test is finished, when 100% test progress is reached. Further on, all test cases, which have to be performed, are known and result in 100% test cases. The drawback of this “conventional” approach is the uncertainty in terms of prediction accuracy is increasing without using data from historical projects.

FIG. 2 shows an example schematic block diagram illustrating the approach to predict test end data by using data from historical projects and from the current project. Using data from historical projects makes only sense if the historical projects have similar attributes and characteristics as the current project. This requirement is normally fulfilled by release developments of software products. By using test progress and error finding rate data from historical projects, wherein the historical projects are similar to the current project, a gradient is calculated based on these data. The more historical projects are taken into account, the better and accurate is the calculated gradient. Based on the gradient and on test progress, error finding rate and error closing rate from the current project, the test end prognosis for the current project is calculated. Hence the parameters of the reliability growth model are not only estimated based on the fault detection rate but also on the remaining time until a test progress of a 100% is reached and on gradients derived from historical similar projects. This improves the accuracy of the model and of the prediction.

The idea is the combination of different information in order to get a better and improved prediction model earlier in software test, especially in system test. The model will support project managers, test managers and especially system test managers with reliable data about remaining necessary test time and faults to be closed. According to these information, the effort for fault detection or fault closure can be adjusted.

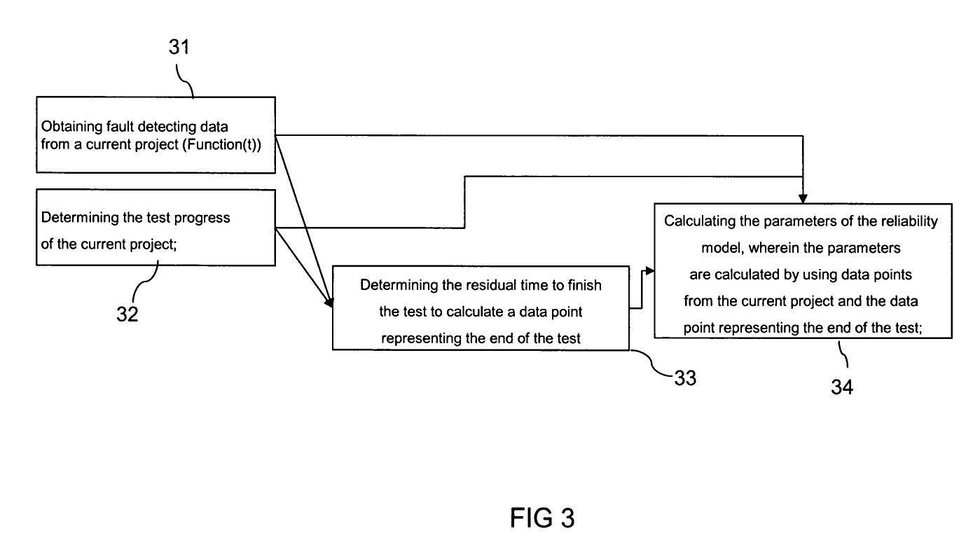

FIG. 3 shows an example schematic overview flow diagram to calculate parameters of the reliability growth model by using the residual (remaining) time to finish the test of the current project. In FIG. 3 the rectangles represent process steps to be performed, the arrows represent data flow between the process steps. The process steps and the data flow between the steps are implemented using hardware (e.g. Laptop, Personal Computer) or software (e.g. spreadsheet programs or by dedicated or adapted test software). Obtaining fault detecting data from a current project 31 as a function(t) and determining the test progress 32 of the current project can automatically accomplished by Test Management Systems (software programs which record and process error data derived from a project, especially from software development projects).

The remaining or residual test time (t_{remaining}) at time t₀ can be determined 33 or calculated with the following formula. It is assumed, that a 100% test progress has to be reached:

$${t}_{remaining} = \frac{1 - testprogress\_reached ( {t}_{0} )}{testprogress\_\_average ( {t}_{0} )} + {t}_{0}$$

A benefit of step 33 is that the parameters of the reliability growth model are not only estimated based on the fault detection rate but also on the remaining time (t_{remaining}) until a test progress of a 100% is reached.

Calculating 34 the parameters of the reliability model, wherein the parameters are calculated by using data points from the current project and the data point representing the end of the test assumes that a polynomial of 2nd degree is used as the reliability growth model. Furthermore it is assumed, that the fault detection curve is approximately a polynomial of 2nd degree:

prediction_fault_finding(t)=c₂×t²+c₁×t+c₀

whereas t is the point of time in test and prediction_fault_finding(t) is the fault finding at point of time t. The parameters c₂, c₁, c₀ are approximated based on the actual test progress and can be automatically calculated with the least squares method by using a suitable software program. It is assumed further on, that the test progress is linear. This means, that the test progress will increase linear according to average test progress in that project. The test progress is defined in percentage with the following formula:

$$testprogress\_reached ( t ) = \frac{\sum testcases\_performed \_positive ( t )}{\sum all\_testcases} \times 100 \%$$

$$testprogress\_average ( t ) = \frac{testprogress\_reached}{t}$$

Test cases_performed_positive are those test cases, where the tester was not able to find a deviation between the software under test and the test specification.

Advantages of taking into account the residual time to finish the test:
Test progress and fault detection rate are taken into account. The impact of random deviations on one of the measures is reduces by combining them.
The accuracy of predicting residual time and number of faults detected increases.
It can be evaluated, if all faults will be closed at 100% test progress by comparing fault detection and fault closing rate.
Fault detection rate and/or fault closure rate can be adjusted accordingly e.g. by adjustment of test resources.

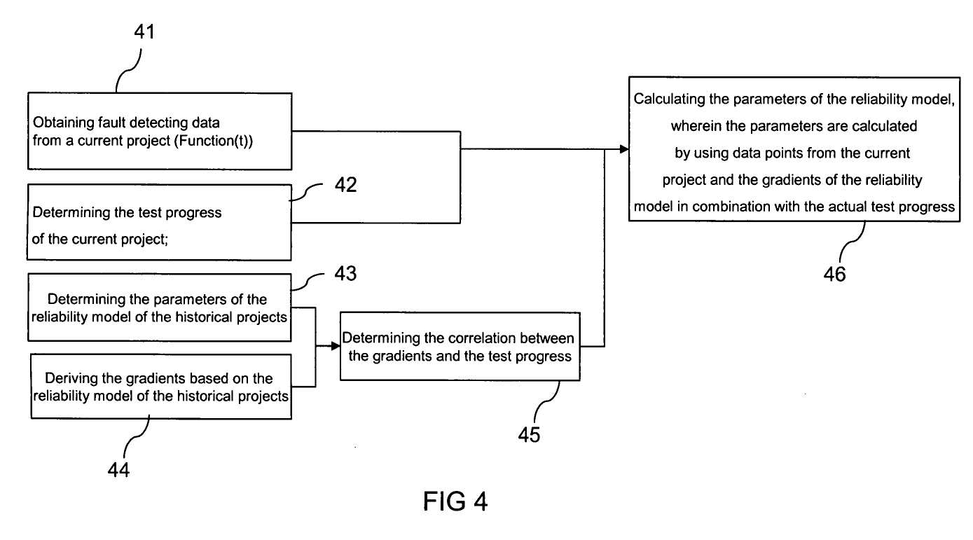

FIG. 4 shows an example schematic overview flow diagram to calculate parameters of the reliability growth model by using gradients derived from data of historical projects. In FIG. 4 the rectangles represent process steps to be performed, the arrows represent data flow between the process steps. The process steps and the data flow between the steps are implemented using hardware (e.g. Laptop, Personal Computer) or software (e.g. spreadsheet programs or by dedicated or adapted test software). Obtaining 41 fault detecting data from a current project as a function(t) and determining 42 the test progress of the current project can automatically accomplished by Test Management Systems (software programs which record and process error data derived from a project). Determining 43 the parameters of the reliability model of the historical projects can be implemented by using commercially available spreadsheet (e.g. Excel) programs, wherein the data of the historical projects are obtained by access to a storage medium (e.g. data base, computer readable medium). Deriving 44 the gradients based on the reliability model of the historical projects uses the following formula:

$$The model is \text{:} fault\_finding ( t ) = {c}_{2} \times {t}^{2} + {c}_{1} \times t + {c}_{0}$$

$$\frac{d ( fault\_finding ( t ) )}{d t} = 2 \times {c}_{2} \times t + {c}_{1}$$

$$gradient ( t ) = \frac{d ( fault\_finding ( t ) )}{d t}$$

$$gradient ( t ) = 2 \times {c}_{2} \times t + {c}_{1}$$

wherein the parameters c₂, c₁, c₀ can be automatically calculated with the least squares method by using a suitable software program e.g. a spreadsheet program. To calculate the gradient based on one single historical project, the fault detection curve of said historical project is approximated with a reliability growth model according to the Rayleigh model, the Jelinsk-Morana model, the Goel-Okumoto model, the Musa-Okumoto model or the Littlewood-Verrall model. For said single historical project, the deviation of that reliability growth model and the test progress is brought into correlation.

Determining 45 the correlation between the gradients and the test progress can be implemented by using a spreadsheet program. For every time unit, test progress and gradient are set into correlation:

gradient(testprogress)=g₂×testprogress²+g₁×testprogress+g₀

wherein the polynomial parameters g₂, g₁ and g₀ can be determined by using the least square method. Calculating 46 the parameters of the reliability model, wherein the parameters are calculated by using data points from the current project and the gradients of the reliability model in combination with the actual test progress can be implemented by using a spreadsheet program running on a commercially available computer. In step 46 additionally to the test progress of the current project also the gradient of at least one historical project is used to estimate the deviation of the reliability growth model at t₀ and for prediction of t_{tremaining}. Usage of typical fault detection rates from historical projects improves the prediction model and there is no uncertainty about future test progress. Prerequisite is that historical project must have similar characteristics of the current project in terms of size, duration and complexity. This prerequisite is normally given in software release development. By using more than one historical project individual characteristics of a historical project are eliminated. When using a plurality of historical projects, the fault detection curve of these historical projects are approximated by a reliability growth model according to the Rayleigh model, the Jelinsk-Morana model, the Goel-Okumoto model, the Musa-Okumoto model or the Littlewood-Verrall model. The deviation of all reliability growth models of the historical projects and the related test progress are brought into correlation.

Following process steps among others can be realized with standard spreadsheet software: the transformation of the data, the calculation of the parameters for the reliability growth model, the calculation of the deviation of the reliability growth model from historical projects and the drawing of test progress, fault finding curve, fault closing curve.

Advantages of using data from historical projects to predict the remaining test time:
The characteristic of historical projects and the parameter of reliability growth model are taken into consideration.
By taken historical data into account, the impact of random deviations on one of the measures of the current project is reduced by combining them with the gradient, calculated in the historical project.
The accuracy of predicting the parameter of the reliability model of the current project increases.
It can be evaluated, if all faults will be closed at 100% test progress by comparing fault detection and fault closing rate.
Fault detection rate and/or fault closure rate can be adjusted accordingly.

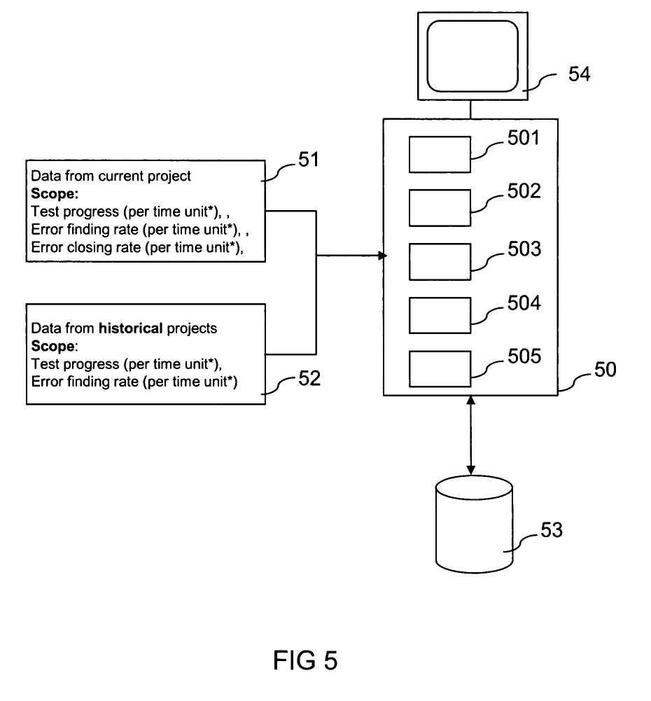

FIG. 5 shows an example schematic block diagram illustrating inputs and outputs of the processing unit 50 to perform the process steps of the present invention. The invention may be implemented using Hardware and/or Software. The arrows represent the data flow to and from the processing unit 50. The processing unit 50 can be a computer (e.g. laptop, workstation, server, Personal Computer) having a commercial off the shelf operating system (e.g. Windows, Linux) and comprising a processor, a memory, input means (e.g. keyboard, mouse), and output means 54 (e.g. a displaying unit, monitor) for displaying the remaining test time or the remaining errors of the current project. The processing unit 50 can be connected to an external memory 53 (e.g. a data base, external drive) for storing or archiving the results or for accessing data of historical projects. The processing unit 50 comprises a first error detection unit 501 for identifying errors in the current project 51, a first determination unit 502 for determining a test progress, an error finding rate and an error closing rate per time unit based on the identified errors of the current project 51, wherein a residual time to finish the test of the current project is determined by calculating a data point representing the end of the test, a second error detection unit 503 for identifying errors of at least one historical project having similar characteristics as the current project, and a second determination unit 504 for determining the test progress and the error finding rate and per time unit of each respective historical project 52 based on the respective errors and determining the parameters of a reliability growth model of the historical projects based on the test progress and the error finding rate of the respective historical projects 52. Data from the current project can be automatically provided by Test Management Systems (TMS), error tracking tools or change management systems.

The processing unit 50 further comprises a calculating unit 505 for deriving a gradient based on the reliability growth model of the historical projects, for calculating parameters of a reliability growth model of the current project, wherein the parameters are calculated by using data points derived from the current project, the test progress of the current project, the error finding rate of the current project, the error closing of the current project, and the gradient of the historical projects, and for determining the residual test time or the residual errors of the current project based on a correlation between the gradient of the historical projects and the fault detecting data from the current project;

The units 501 to 505 of the processing unit 50 and the mechanisms used for accessing and transferring data can be realized with standard components. E.g. spreadsheet software for the transformation of the data, for the calculation of the parameters for the reliability growth model, for the calculation of the deviation of the reliability growth model from historical projects and the drawing of test progress, for determining fault finding curves or fault closing curves.

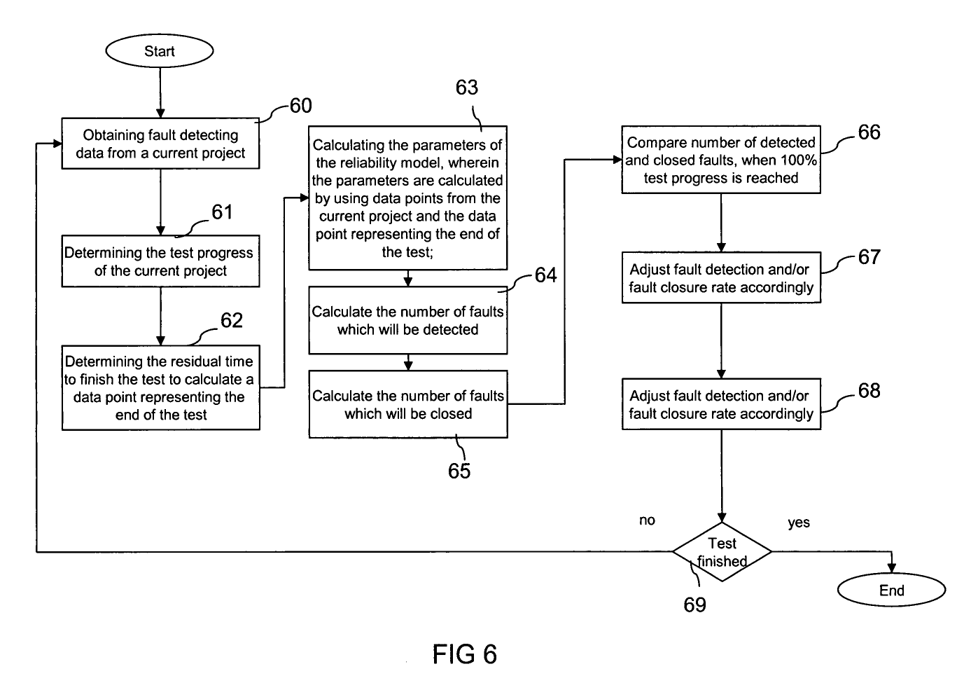

FIG. 6 shows a detailed flow diagram to calculate parameters of the reliability growth model by using the test progress of the current project. The test progress is thereby used as an input for the estimation of the parameters of the reliability growth model used to predict the remaining test time or the remaining number of errors. The rectangles in FIG. 6 represent process steps, the arrows represent the data flow between process steps, the ovals represent the starting point respective the end of the flow diagram, and the diamond symbol represents a decision within the flow diagram.

The process step 60 obtaining fault detecting data from a current project can be accomplished by commercially available error tracking tools. The process steps 61 determining the test progress of the current project, 62 determining the residual time to finish the test to calculate a data point representing the end of the test, 63 calculating the parameters of the reliability model, wherein the parameters are calculated by using data points from the current project and the data point representing the end of the test, 64 calculate the number of faults which will be detected, 65 calculate the number of faults which will be closed, 66 compare number of detected and closed faults, when 100% test progress is reached, 67 adjust fault detection and/or fault closure rate accordingly, and 68 adjust fault detection and/or fault closure rate accordingly can be implemented and performed by spreadsheet programs (e.g. Excel). The decision symbol 69 after the process step 68 represents a monitoring to decide whether the test is finished. If the test is finished, the end of the procedure is reached. If the test is not finished, the procedure continues with step 60. After finishing step 68 there is again a decision whether the test is finished. A test end criterion can be: Were all planned test cases successfully performed?

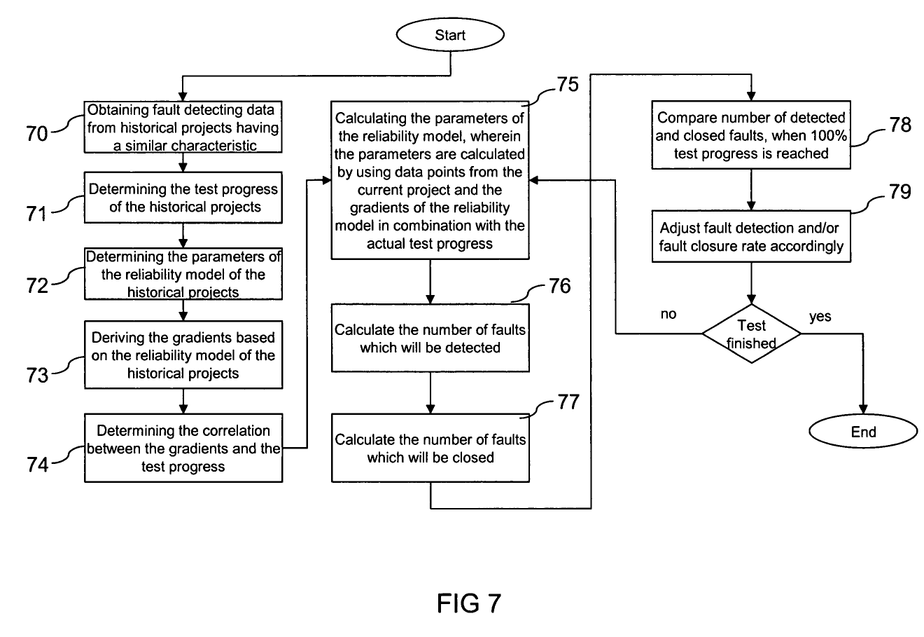

FIG. 7 shows a detailed flow diagram to calculate parameters of the reliability growth model by using gradients derived from data of historical projects. In order to improve the estimation of the parameters of the reliability growth model, data of at least one former project is used and evaluated by bringing the deviation of that reliability growth model and the test progress of the current project into correlation. The rectangles in FIG. 7 represent process steps, the arrows represent the data flow between process steps, the ovals represent the starting point respective the end of the flow diagram, and the diamond symbol represents a decision within the flow diagram.

The process step 70 obtaining fault detecting data from historical projects having a similar characteristic (in terms of size, duration and complexity) can be accomplished e.g. by data base access to archived data of historical projects. This prerequisite is normally given in software release development. The process steps 71 determining the test progress of the historical projects, 72 determining the parameters of the reliability model of the historical projects, 73 deriving the gradients based on the reliability model of the historical projects, 74 determining the correlation between the gradients and the test progress, 75 calculating the parameters of the reliability model, wherein the parameters are calculated by using data points from the current project and the gradients of the reliability model in combination with the actual test progress, 76 calculate the number of faults which will be detected, 77 calculate the number of faults which will be closed, 78 compare number of detected and closed faults, when 100% test progress is reached, and 79 adjust fault detection and/or fault closure rate accordingly can be implemented and performed by spreadsheet programs (e.g. Excel). The decision symbol after the process step 79 represents a monitoring to decide whether the test is finished. If the test is finished, the end of the procedure is reached. If the test is not finished, the procedure continues with step 75. After finishing step 79 there is again a decision whether the test is finished. A test end criterion can be: Were all planned test cases successfully performed?

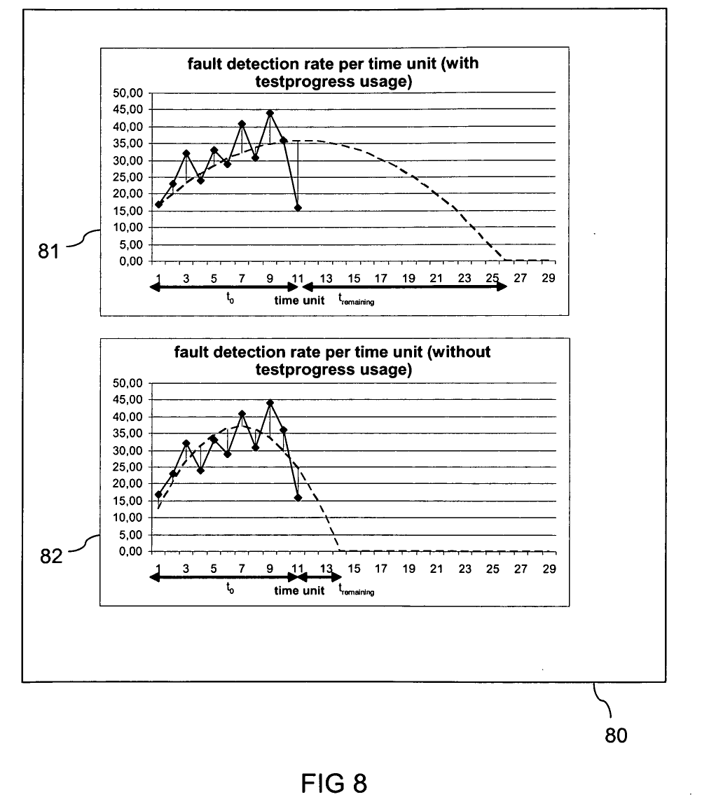

FIG. 8 shows two output diagrams, the upper diagram 81 shows the results of calculating the fault detection rate with use of the test progress, the lower diagram 82 shows the results of calculating the fault detection rate without using the test progress. The output diagrams 81, 82 can be displayed on a displaying unit 80 (e.g. monitor, display) of a computer. As mentioned before it is assumed, that the fault detection curve is approximately a polynomial of 2nd degree:

prediction_fault_finding(t)=c₂×t²+c₁×t+c₀

whereas t is the point of time in test and prediction_fault_finding(t) is the fault finding at point of time t. The parameters c₂, c₁, c₀ are approximated based on the actual test progress and can be automatically calculated with the least squares method by using a suitable software program. In the upper diagram 81 the parameters c₂, c₁, c₀ for calculating the fault detection rate are determined by using the test progress. In the lower diagram 82 the parameters c₂, c₁, c₀ for calculating the fault detection rate are determined without using the test progress. Table 1 presents example data (number of faults detected) for determining the fault detection rate per time unit (week). In the diagrams 81 and 82 the curves for illustrating the fault detection rates are displayed in broken lines.

Disadvantages of a reliability growth model without taking into account the test progress are:
The parameters of the reliability growth model are calculated without knowing the realistic test end.
The estimated time t_{remaining} is too short (can be also too long in other examples).
The estimation of faults, detected after t₀ too low or too high, which leads to faulty estimation results.
Effort for fault closing is underestimated or overestimated, which leads to faulty estimation results.

A countermeasure could be: Use one additional data point, in the example week 23 (see table 1), where a 100% test progress is assumed and set fault detection number for that week 100%.

TABLE 1
Example data for determining the fault detection rate

| Week | #fault detected |
|---|---|
| 0 | 0 |
| 1 | 17 |
| 2 | 23.00 |
| 3 | 32.00 |
| 4 | 24.00 |
| 5 | 33.00 |
| 6 | 29.00 |
| 7 | 41.00 |
| 8 | 31.00 |
| 9 | 44.00 |
| 10 | 36.00 |
| 11 | 16.00 |
| 23 | |

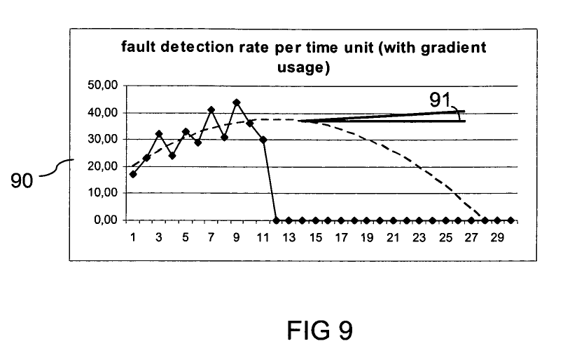

FIG. 9 shows an output diagram 90 illustrating the calculated curve for the fault detection rate (illustrated by the broken line) per time unit (week) by using the gradient 91 derived from at least one historical project. The fault detection curve as shown in FIG. 9 bases also on the example data provided in table 1. Compared to the results shown in diagram 81 (fault detection rate per time unit with test progress use) the diagram 90 shows a further improvement by estimating a realistic test end time (week 28 in FIG. 90).

In principle the calculation of the fault detection curve (broken line) is as followed:

$$\begin{matrix}[ \begin{matrix}0 & 0 & 1 \\ \# {week}^{2} & \# week & 1 \\ test\_end {\_week}^{2} & test\_end \_week & 1\end{matrix} ] \times ( \begin{matrix}{c}_{2} \\ {c}_{1} \\ {c}_{0 }\end{matrix} ) - ( \# fault\_detected ( week ) ) = MIN & \\ with {c}_{2} = \frac{Gradient ( test\_progress ) - {c}_{1}}{2 \times t} & \end{matrix}$$

In the example calculation of the fault detection curve (broken line) is as followed:

$$[ \begin{matrix}0 & 0 & 1 \\ \# {week}^{2} & \# week & 1 \\ test\_end {\_week}^{2} & test\_end \_week & 1\end{matrix} ] \times ( \begin{matrix}\frac{Gradient ( test\_progress ) - {c}_{1}}{2 \times t} \\ {c}_{1} \\ {c}_{0 }\end{matrix} ) - ( \# fault\_detected ( week ) ) = MIN$$

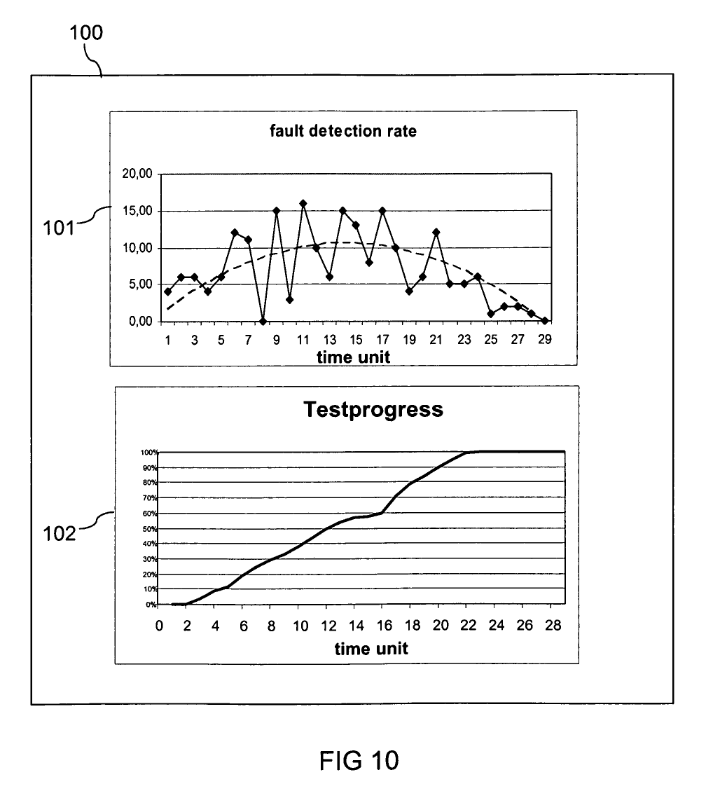

FIG. 10 shows an example image on a displaying unit illustrating output results of the present invention.

FIG. 10 shows an example image on a displaying unit 100 illustrating output results 101, 102 of the present invention. As a displaying unit 100 a display, a screen or a monitor can be used to provide results of an embodiment of the invention performed on a processing unit in textual or graphical form. The results can be provided by using dedicated windows on the displaying unit 100 of a computer. Window 101 shows a curve illustrating fault detection rate per time unit (e.g. hour, day, week, month) and window 102 shows a curve illustrating the test progress corresponding to the fault detection rate shown in window 101. A project leader, a test manager (especially a system test manager) can benefit having these data by planning, keeping track and reporting of a software project to the senior management.

A computer implemented method and a system for predicting the remaining numbers of error or the remaining time to the end of test mainly applicable in software projects. The prediction can be improved by using the test progress of the current project and the gradient derived from at least one former project having similar characteristics as the current project e.g. release developments for determining parameters for a reliability growth model. The method and the system can be implemented by adapted software and hardware commercially available off the shelf.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for predicting residual test time of a current project, the method comprising:
providing fault detecting data from the current project;
determining a test progress per time unit based on the fault detecting data of the current project;
determining an error finding rate per time unit based on the fault detecting data of the current project;
determining an error closing rate per time unit based on the fault detecting data of the current project;
projecting a residual time to finish the test of the current project by calculating a data point representing the end of the test;
providing fault detecting data from at least one historical project having similar characteristics as the current project;
determining the test progress per time unit of each respective historical project based on the respective fault detecting data;
determining the error finding rate per time unit of each respective historical project based on the fault detecting data;
determining the parameters of a reliability growth model of the historical projects based on the test progress, and the error finding rate of the respective historical projects;
deriving a gradient based on the reliability growth model of the historical projects;
calculating parameters of a reliability growth model of the current project, wherein the parameters are calculated by using data points derived from the current project, the test progress of the current project, the error finding rate of the current project, the error closing of the current project, and the gradient of the historical projects;
determining the residual test time of the current project based on a correlation between the gradient of the historical projects and the fault detecting data from the current project; and
displaying the residual test time on a monitor.

2. The method according to claim 1, wherein the method is used to determine the residual system test time of the current project.

3. The method according to claim 1, wherein the method is used to determine the residual errors of the current project.

4. The method according to claim 1, wherein the historical projects are release developments.

5. The method according to claim 1, wherein the reliability growth model is the Rayleigh model, the Jelinsk-Morana model, the Goel-Okumoto model, the Musa-Okumoto model or the Littlewood-Verrall model.

6. The method according to claim 1, wherein the fault detecting data are found errors in the current or in an historical project.

7. The method according to claim 1, wherein in the calculating of parameters of a reliability growth model of the current project, the parameters are calculated by using also the data point representing the end of the system test of the current project.

8. The method according to claim 1, wherein the method is performed by software executed by a computer.

9. A computer readable medium, having a program recorded thereon, wherein the program when executed is to make a computer execute the method comprising:
providing fault detecting data from the current project;
determining a test progress per time unit based on the fault detecting data of the current project;
determining an error finding rate per time unit based on the fault detecting data of the current project;
determining an error closing rate per time unit based on the fault detecting data of the current project;
projecting a residual time to finish the test of the current project by calculating a data point representing the end of the test;
providing fault detecting data from at least one historical project having similar characteristics as the current project;
determining the test progress per time unit of each respective historical project based on the respective fault detecting data;
determining the error finding rate per time unit of each respective historical project based on the fault detecting data;
determining the parameters of a reliability growth model of the historical projects based on the test progress, and the error finding rate of the respective historical projects;
deriving a gradient based on the reliability growth model of the historical projects;
calculating parameters of a reliability growth model of the current project, wherein the parameters are calculated by using data points derived from the current project, the test progress of the current project, the error finding rate of the current project, the error closing of the current project, and the gradient of the historical projects; and
determining the residual test time of the current project based on a correlation between the gradient of the historical projects and the fault detecting data from the current project.

10. The computer readable medium according to claim 9, further comprising instructions for the calculating of parameters of a reliability growth model of the current project, wherein the parameters are calculated by using also the data point representing the end of the system test of the current project.

11. A system for predicting residual test time of a current project, the system comprising:
a mechanism for providing fault detecting data from the current project;
a mechanism for determining a test progress, an error finding rate and an error closing rate per time unit by using the fault detecting data of the current project;
a mechanism for projecting a residual time to finish the test of the current project by calculating a data point representing the end of the test;
a mechanism for providing fault detecting data from at least one historical project having similar characteristics as the current project;
a mechanism for determining the test progress and the error finding rate per time unit of each respective historical project by using the respective fault detecting data;
a mechanism for determining the parameters of a reliability growth model of the historical projects by using the test progress and the error finding rate of the respective historical projects;
a mechanism for deriving a gradient by using the reliability growth model of the historical projects;
a mechanism for calculating parameters of a reliability growth model of the current project, wherein the parameters are calculated by using data points derived from the current project, the test progress of the current project, the error finding rate of the current project, the error closing of the current project, and the gradient of the historical projects; and
a mechanism for determining the residual test time of the current project by using a correlation between the gradient of the historical projects and the fault detecting data from the current project.

12. The system according to claim 11, wherein the system is used to determine the residual system test time of the current project.

13. The method according to claim 11, wherein the system is used to determine the residual errors of the current project.

14. The system according to claim 11, wherein the historical projects are release developments.

15. The system according to claim 11, wherein the reliability growth model is the Rayleigh model, the Jelinsk-Morana model, the Goel-Okumoto model, the Musa-Okumoto model or the Littlewood-Verrall model.

16. The system according to claim 11, wherein the fault detecting data are found errors in the current or in an historical project.

17. The system according to claim 11, wherein the mechanism for calculating parameters of a reliability growth model of the current project is using the data point representing the end of the system test of the current project.

18. The system according to claim 11, wherein the mechanisms used to implement the system are suitable and adapted commercial off the shelf products.

19. A system for determining residual test time or residual errors of a current development project, the system comprising:
a first error detection unit for identifying errors in the current project;
a first determination unit for determining a test progress, an error finding rate and an error closing rate per time unit based on the identified errors of the current project, wherein a residual time to finish the test of the current project is determined by calculating a data point representing the end of the test;
a second error detection unit for identifying errors of at least one historical project having similar characteristics as the current project;
a second determination unit for
determining the test progress and the error finding rate and per time unit of each respective historical project based on the respective errors; and
determining the parameters of a reliability growth model of the historical projects based on the test progress, and the error finding rate of the respective historical projects;
a calculating unit for
deriving a gradient based on the reliability growth model of the historical projects;
calculating parameters of a reliability growth model of the current project, wherein the parameters are calculated by using data points derived from the current project, the test progress of the current project, the error finding rate of the current project, the error closing of the current project, and the gradient of the historical projects; and
determining the residual test time or the residual errors of the current project based on a correlation between the gradient of the historical projects and the fault detecting data from the current project; and
a displaying unit for displaying the residual test time or the residual errors.
